(19) United States
(12) Patent Application Publication
(10) Pub. No.: US 2016/0017937 A1
(43) Pub. Date: Jan. 21, 2016

(54) ROCKER ONE-WAY CLUTCH

(71) Applicant: Schaeffler Technologies AG & Co. KG, Herzogenaurach (DE)

(72) Inventors: Trevor McConnell, Rittman, OH (US); Gregory Blough, Wooster, OH (US); Markus Steinberger, Macedonia, OH (US); Jacob Rufener, Rittman, OH (US); Bohua Zhang, Toledo, OH (US)

(73) Assignee: SCHAEFFLER TECHNOLOGIES AG & CO. KG, Herzogenaurach (DE)

(21) Appl. No.: 14/798,970

(22) Filed: Jul. 14, 2015

Related U.S. Application Data
(60) Provisional application No. 62/024,806, filed on Jul. 15, 2014.

(51) Int. Cl. F16D 41/12

(52) U.S. Cl. CPC F16D 41/12; F16D 2127/10

(57) ABSTRACT

A rocker one-way clutch includes a stator housing, an inner race, and a strut. The stator housing has a strut pocket and a plurality of stator blades. The inner race has a first angled contact face. The strut is disposed in the strut pocket and has a second angled contact face arranged to contact the first angled contact face. In an example embodiment, an angle between a line passing from the contact face to a rocker pivot center and a line parallel to the contact face is acute. In an example embodiment, the acute angle is approximately 10 degrees.

### FIELD

The invention relates generally to a one-way clutch, and more specifically to a rocker one-way clutch with improved engagement features.

### BACKGROUND

Rocker one-way clutches are known. One example is shown in commonly-assigned United States Patent Application Publication No. 2014/0197002, hereby incorporated by reference as if set forth fully herein.

### BRIEF SUMMARY

Example aspects broadly comprise a rocker one-way clutch including a stator housing including a strut pocket and a plurality of stator blades, an inner race with a first angled contact face, and a strut disposed in the strut pocket and including a second angled contact face arranged to contact the first angled contact face. In some example embodiments, an angle between a line passing from the contact face to a rocker pivot center and a line parallel to the contact face is acute. In an example embodiment, the acute angle is approximately 10 degrees.

Other example aspects broadly comprise a rocker element for a one-way clutch including a cylindrical portion, a connector portion extending radially from the cylindrical portion, and an end segment including a distal face disposed at an acute angle to a plane orthogonal to the connector portion. In an example embodiment, a thickness of the end segment is greater than a thickness of the connector portion. In an example embodiment, the connector portion and the end segment combine to form a pocket for receiving a spring element.

Other example aspects broadly comprise a one-way clutch assembly including the rocker element and a tubular inner race including a plurality of radial extensions. Each radial extension includes an edge extending radially outward at an acute angle to a radial line passing through the edge and a center of the inner race and arranged for contacting the rocker element end segment distal face and an outer ramped portion including first and second non-coplanar ramped surfaces. In an example embodiment, the inner race has an inner spline.

Other example aspects broadly comprise a stator for a torque converter including the one-way clutch assembly, a stator housing including a first cylindrical pocket and a second pocket, and a spring element disposed in the second pocket and in contact with the rocker element. The rocker element is disposed in the first cylindrical pocket and is arranged to contact the inner race. In an example embodiment, the rocker element is arranged to contact the inner race edge and at least one of the ramped surfaces.

### BRIEF DESCRIPTION OF THE DRAWINGS

The nature and mode of operation of the present invention will now be more fully described in the following detailed description taken with the accompanying drawing figures, in which:

FIG. 1 is a front view of a torque converter stator assembly with a prior art rocker one-way clutch according to an example aspect;

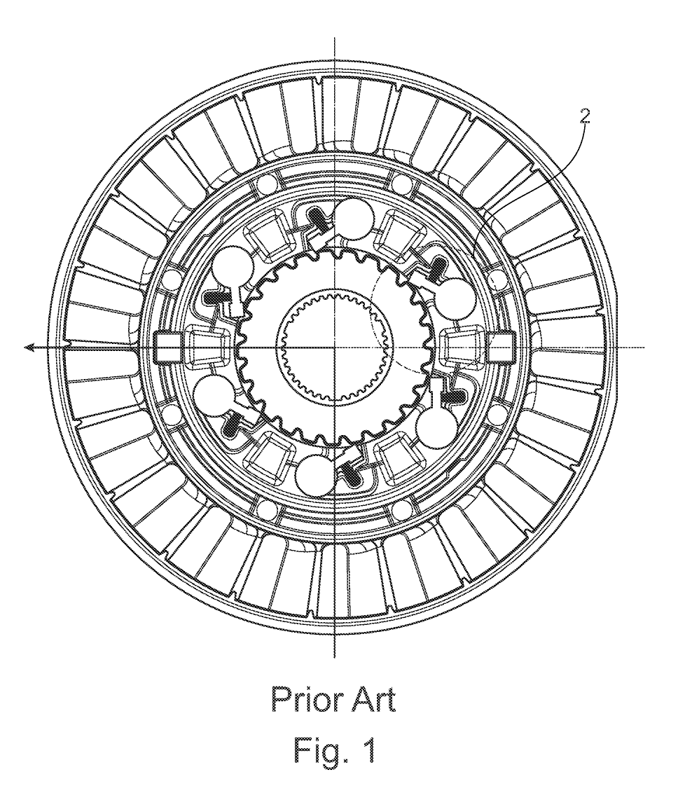

FIG. 2 is a detail back view of encircled region 2 in FIG. 1;

FIG. 3 is a detail back view of a rocker one-way clutch with an angled contact face showing force vectors according to an example aspect;

FIG. 4 is a detail back view of a rocker one-way clutch with an angled contact face according to an example aspect;

FIG. 5 is a detail view of a rocker one-way clutch with an angled contact face in a disengaged position according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

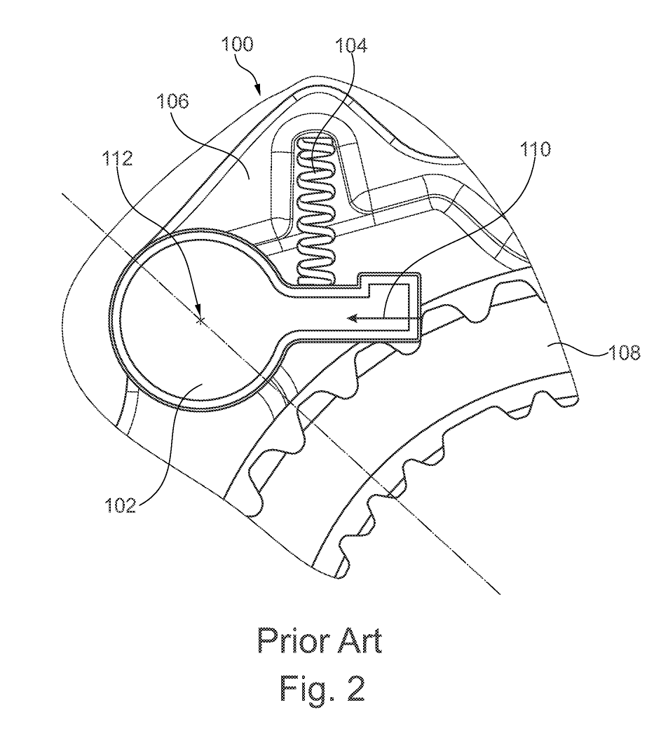

The following description is made with reference to FIG. 2. FIG. 2 is a detail view of prior art rocker one-way clutch 100. Clutch 100 includes strut 102, spring 104, stator housing 106, and inner race 108. General operation of clutch 100 is similar to the one-way clutch shown and described in commonly-owned United States Patent Publication No. 2014/0197002 to Lindemann et al. and will not be repeated. In general, clutch 100 is designed so that a normal force (indicated by vector line 110 in FIG. 2) is inline with a centerline (i.e., as indicated by cross 112) of the strut. It is believed that this geometry is optimal for loading through the stator housing and the strut. Unfortunately, testing has shown that the strut and inner race have a tendency for partial engagement resulting in higher unit loading and corresponding wear in the parts.

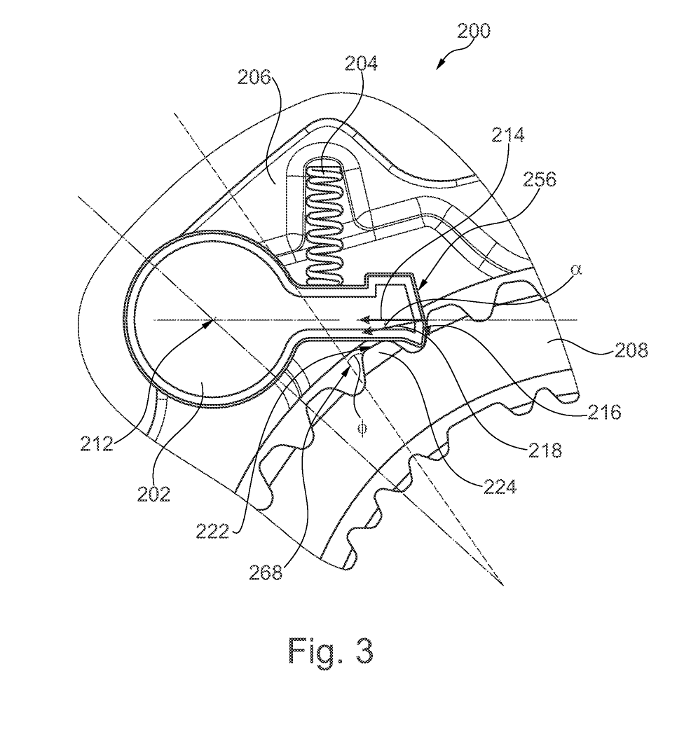

The following description is made with reference to FIG. 3. FIG. 3 is a detail view of rocker one-way clutch 200 with an angled contact face according to an example aspect. Clutch 200 includes strut 202, spring 204, stator housing 206, and inner race 208. General operation of clutch 200 is similar to the one-way clutch shown and described in commonly-owned United States Patent Publication No. 2014/0197002 to Lindemann et al. and will not be repeated.

In this embodiment, a contact area between the strut and race is designed at angle α to a line passing through centerline 212 indicated by tangential force vector 214. In an example embodiment, angle α is approximately 10°, although other angles are possible. This angle generates a radial force component indicated by vector 216. A combined vector force 218 includes the radial force that helps pull the strut into full engagement with the race. That is, during engagement of the strut to the race, contact between the two components drives the strut radially inward to better engage a tooth of the race. This prevents the partial engagement condition as seen in the prior art. Inner race 208 includes respective teeth 224, each with an edge 268 extending radially outward at an acute angle φ to radial line 270 passing through the edge and a center of the inner race. Edge 268 is arranged for contacting rocker element end segment distal face 256.

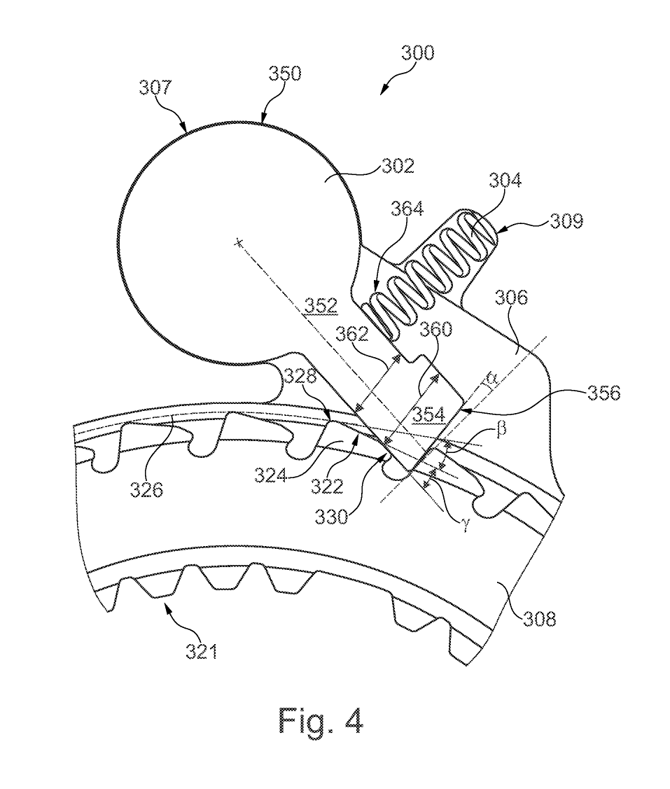

The following description is made with reference to FIG. 4. FIG. 4 is a detail view of rocker one-way clutch, or one-way clutch assembly, 300 with an angled contact face according to an example aspect. Clutch 300 includes strut, or rocker element, 302, spring, or spring element, 304, stator housing 306, and inner race 308. Stator housing 306 includes cylindrical pocket 307 and pocket 309. Rocker element 302 is disposed in pocket 307 and arranged to contact inner race 308. Spring element 304 is disposed in pocket 309 and contacts the rocker element.

General operation of clutch 300 is similar to the one-way clutch shown and described in commonly-owned United States Patent Publication No. 2014/0197002 to Lindemann et al. and will not be repeated Inner race, or tubular inner race, 308 includes a plurality of teeth, or radial extensions, 320. Teeth 320 include geometry that has been strategically updated to improve dynamics of the rocker one-way clutch in a torque converter. Inner race 308 includes inner spline 321.

Rocker element 302 includes cylindrical portion 350, connector portion 352 extending radially from the cylindrical portion and an end segment 354 including distal face 356 disposed at acute angle α to plane 358 orthogonal to the connector portion. Thickness 360 of the end segment is greater than thickness 362 of the connector portion. The connector portion and the end segment combine to form pocket 364 for receiving spring element 304.

As described above, an inner race tooth lockup angle has been adjusted to help prevent partial engagements. Furthermore, in contrast to race 208 shown in FIG. 3, angle β has been adjusted so that the strut can drop off the tooth quicker. That is, instead of a nearly circumferential surface (i.e., surface 222 of tooth 224 in FIG. 2), surface 322 extends at an angle β to circumferential line 326 permitting the strut to start engaging tooth 324 as soon as it passes over corner 328. A tooth profile leading into the lockup position has also been reduced (i.e., by angle γ between surfaces 330 and 322) to bring the strut lower and closer in the lock-up position. In other words, teeth 324 include an outer ramped portion including non-coplanar ramped surfaces 322 and 330. In an engaged position, rocker element 302 contacts inner race edge 366 and ramped surface 330. This helps prevent bending of the strut and/or inner race tooth.

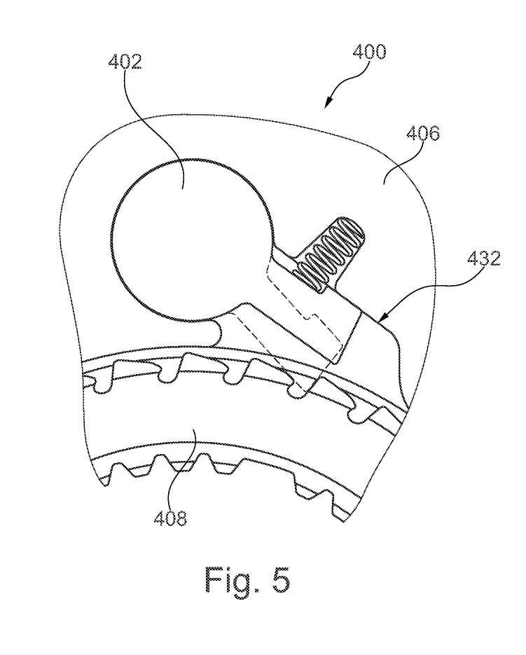

The following description is made with reference to FIGS. 5. FIG. 5 is a detail view of rocker one-way clutch 400 with an angled contact face according to an example aspect. Material has been added in stator housing 406 at strut liftoff area 432 to reduce an engagement time of strut 402 with inner race 408. That is, the additional material at the strut lift-off contact face pushes the strut radially inward and closer to the inner race for reduced engagement travel during lock-up.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A rocker one-way clutch comprising:
a stator housing including a strut pocket and a plurality of stator blades;
an inner race with a first angled contact face; and,
a strut disposed in the strut pocket and including a second angled contact face arranged to contact the first angled contact face.

2. The rocker one-way clutch of claim 1 wherein an angle between a line passing from the contact face to a rocker pivot center and a line parallel to the contact face is acute.

3. The rocker one-way clutch of claim 2 wherein the acute angle is approximately 10 degrees.

4. A rocker element for a one-way clutch comprising:
a cylindrical portion;
a connector portion extending radially from the cylindrical portion; and,
an end segment including a distal face disposed at an acute angle to a plane orthogonal to the connector portion.

5. The rocker element of claim 4 wherein a thickness of the end segment is greater than a thickness of the connector portion.

6. The rocker element of claim 4 wherein the connector portion and the end segment combine to form a pocket for receiving a spring element.

7. A one-way clutch assembly comprising:
the rocker element of claim 4; and,
a tubular inner race including a plurality of radial extensions, each radial extension including:
an edge extending radially outward at an acute angle to a radial line passing through the edge and a center of the inner race and arranged for contacting the rocker element end segment distal face; and,
an outer ramped portion including first and second non-coplanar ramped surfaces.

8. The one-way clutch assembly of claim 7 wherein the inner race further comprises an inner spline.

9. A stator for a torque converter comprising:
the one-way clutch assembly of claim 7;
a stator housing including a first cylindrical pocket and a second pocket; and,
a spring element disposed in the second pocket and in contact with the rocker element;
wherein the rocker element is disposed in the first cylindrical pocket and is arranged to contact the inner race.

10. The stator of claim 9 wherein the rocker element is arranged to contact the inner race edge and at least one of the ramped surfaces.
